(19) United States
(12) Patent Application Publication
(10) Pub. No.: US 2005/0049914 A1
(43) Pub. Date: Mar. 3, 2005

(54) Systems and methods for a retail system

(76) Inventor: David H. Parish, Minneapolis, MN (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/647,194

(22) Filed: Aug. 25, 2003

(51) Int. Cl. G06F 17/60

(52) U.S. Cl. 705/14; 705/39

(57) ABSTRACT

Disclosed are systems and systems for operating a retail system.

BACKGROUND OF THE INVENTION

1. Field of the Invention

This invention relates generally to systems and methods for a retail system and, more particularly, to systems and methods for marketing to consumers in a retail system.

2. Description of Related Art

Essential elements of marketing to consumers include the timing and content of marketing messages.

In one proposed system, whenever the customer goes shopping he or she goes to a kiosk before beginning shopping and presents a card to a customer interface. A store level computer then accesses information about special offers available to the customer associated with the card, and generates a customized list of special offers. After the customer finishes shopping, the customer presents his or her card to the check out, where the card is scanned. If a customer just bought a product, a targeted special offer can be presented to that customer at a time when it is expected that the customer would run out of the product and would need to purchase more of the product. A problem with this system is a requirement that the customer carry a card.

SUMMARY OF THE INVENTION

It is an object of the present invention to provide systems and methods for marketing to consumers in a retail system.

To achieve this and other objects of the present invention, there is a method for a system including a store. The method comprises the steps, performed in the store, of detecting a first product selected by a consumer; generating a message, a content of the message depending on the first product detected by the detecting step; emitting the message, the emitting step being performed at a first location, the first location being fixed; displaying a price for the first product, the displaying step being performed at a second location different from the first location; and receiving payment from the consumer at the second location.

According to another aspect of the present invention, there is system in a store. The system comprises an output device at a first fixed location; a detector that detects a first product selected by a consumer, to generate a first signal; a generator that generates a message and sends the message to the output device in response to the first signal; and a display that displays a price for the first product, the display being located at a second location different from the first location.

According to yet another aspect of the present invention there is a system in a store. The system comprises means for detecting a first product selected by a consumer; means for generating a message, a content of the message depending on the first product detected by the detecting means; means for emitting the message, the emitting means being at a first fixed location; means for displaying a price for the first product, the displaying means being at a second location different from the first location; and means for receiving payment from the consumer at the second location.

### BRIEF DESCRIPTION OF THE DRAWINGS

References are made to the following description taken in connection with the accompanying drawings, in which:

FIGS. 1A, 1B, and 1C constitute a diagram of a retail store in a first preferred embodiment of the present invention.

FIG. 2 is a diagram of product packages in the store of FIG. 1.

FIG. 3 is a diagram showing various data structures employed in the first preferred system.

FIG. 4 is a diagram showing a part of a data structure of FIG. 3 in more detail.

FIG. 5 is a diagram showing a process performed in the first preferred system.

FIG. 6 is a diagram showing part of the process of FIG. 5 in more detail.

FIG. 7 is a diagram showing part of the process of FIG. 6 in more detail.

FIG. 8 is a diagram showing an instance of a data structure in the first preferred system.

FIG. 9 is a diagram showing another instance of the data structure in the first preferred system.

FIG. 10 is a diagram showing yet another instance of the data structure in the first preferred system.

FIGS. 11A and 11B constitute a diagram of the retail store in the first preferred embodiment, at a different time than the times depicted in FIGS. 1A and 1B.

FIG. 12 is a diagram of a data structure built in response to product detection in the first preferred system.

FIG. 13 is a diagram showing a retail system in accordance with a second preferred embodiment of the present invention.

FIG. 14 is a Flow diagram of the tag sensing and display process

FIG. 15 shows the relationship of the tag reading and checkout POS Point of Sale terminals and targeting database of product RFID tags.

FIG. 16 shows logic of building item(s) read by the sensors and the UPC Universal Product Codes and or SKU Stock Keeping Units relating to the RFID codes.

FIG. 17 is a flowchart of the process of building a database of store level transactions for a cumulative activity of the items sold or movement.

FIG. 18 shows a flowchart of the RFID tag information processed by system 2 for relation to known UPC codes and building the baseline of activity for a product(s) of interest for retailers and manufacturers in terms of characteristics of the products selling features, such as flavor, quantity and size.

FIG. 19 is a flow chart of the process of baseline performance and promotional activity decisions and influencing measurement.

FIG. 20 is a flowchart of the process of building reports based upon client desires.

FIG. 21 is a flowchart of the process of understanding and reporting stock status, promotional response, factitively and measurement.

FIG. 22 shows the process of measuring and reporting base sales and activity of the promotional process.

FIG. 23 is a flowchart of the process of directing the replenishment based upon promotional activity.

FIG. 24 is a flowchart of the process of reporting the influence of promotional activity that offers a change in price or temporary change in price.

FIG. 25 is a flowchart of the reporting process of the promotional activity by store.

FIG. 26 is a diagram of a record file format.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

First Preferred Embodiment

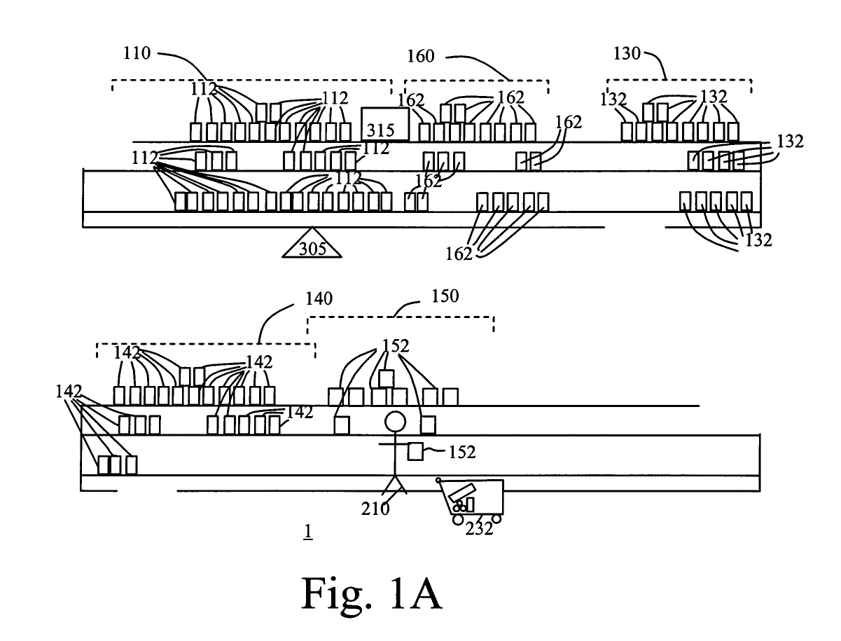

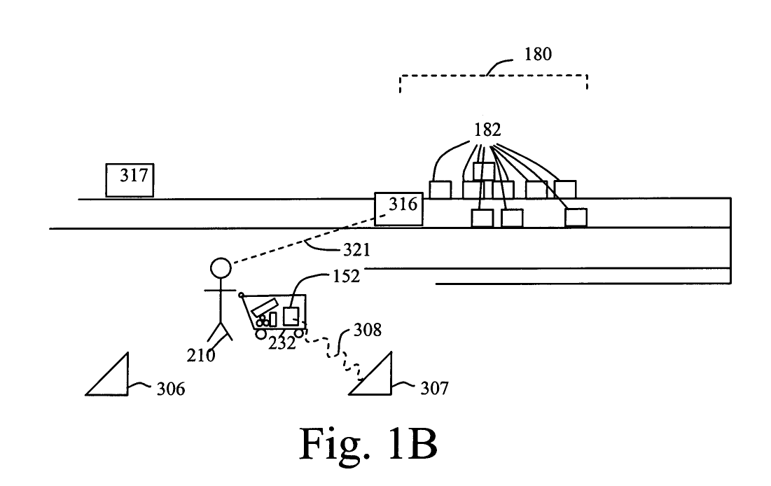

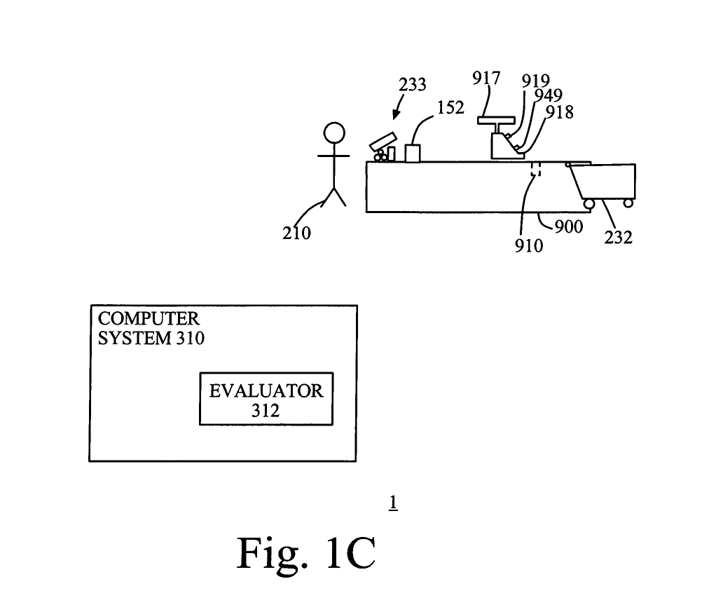

Each of FIGS. 1A, 1B, and 1C is a partial view of system 1, including a store. The store has a plurality of product areas, each corresponding to a respective product. For example, product area 150 has Acme brand tuna, and product area 180 has Beta brand mayonnaise.

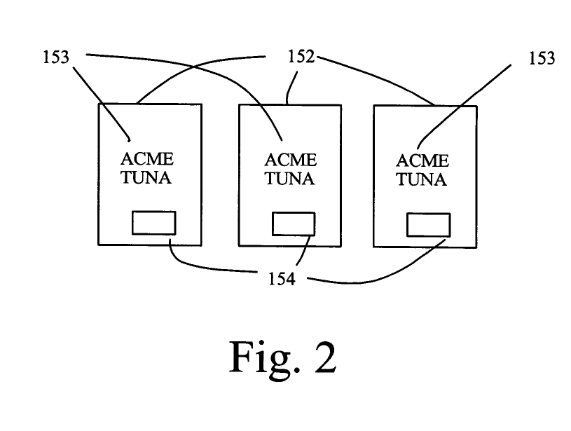

Some of the products have a radio frequency identification (RFID) tag. For example, FIG. 2 shows an enlarged view of cans 152 of Acme brand tuna in product area 150. Each can of tuna 152 has a common RFID tag 154. In response to receiving an interrogation signal, tag 154 emits a radio signal encoding a variety of information, including a 12-digit number that is part of a product identification system documented by the Uniform Code Council, Inc., Dayton, Ohio. In UPC Product Code format, the first digit is a 0, designating a product. The next five digits are a manufacturer identification (ID). The next 5 digits are an item number. The last digit is a check digit. Thus, each tag 154 encodes a number (0 17075 00003 3) that uniquely identifies Acme tuna. In other words, tag 154 is different from RFID tags of units of other products.

Each can of tuna 152 also has a common character visual label 153 that verbally describes the product. Character visual label 153 is “ACME TUNA.” Visual label 153 is different from visual labels of units of other products.

Product Area 180 has jars of mayonnaise 182 grouped together on multiple shelves. Jars of mayonnaise 182 are contiguously grouped, meaning that no other product is between any two jars of mayonnaise 182.

Similarly, other product areas in the store each have a set of respective products contiguously grouped together. Respective units of a certain product have a common RFID tag, different from RFID tags on units of other products, that uniquely identifies the certain product. Respective units of a certain product have a common visual label, different from visual labels on units of other products, that uniquely identifies the certain product.

System 1 includes tag sensing units 305, 306, and 307. Each of sensing units 305, 306, and 307 includes a transmitter for sending an interrogation signal and a receiver for receiving a radio signal emitted by a product RFID tag. When a sensing unit, such as sensing unit 307, receives an identification signal from a tag, unit 307 sends the identification signal to computer system 310.

System 1 also includes display units 315, 316, and 317. Computer system 310 sends respective display signals to each of display screens 315, 316, and 317, allowing consumers in the store to view messages.

Consumer 210 shops in the store. FIG. 1A shows consumer 210 at a certain time at a location in the store. At the time depicted in FIG. 1A, consumer 210 removes a can of tuna 152 and places the can 152 in his shopping cart 232.

FIG. 1B shows consumer 210 at a later time at a different location in the store. At the time depicted in FIG. 1B, consumer 210 pushes his cart 232 through the detection zone of sensor unit 307. Sensor unit 307 detects a radio signal 308 emitted by tag 154 on tuna can 152, and sends a corresponding signal to computer system 310. Computer system 310, in response to the signal received from sensing unit 307, generates a message signal and sends the message signal to display 316, allowing consumer 210 to view a displayed message. In other words, consumer 210 views light signal 321 emitted by display screen 316.

Thus, sensor unit 307 acts to detect a product selected by consumer 210 and, in response to the detected product, sends a signal to computer system 310. Computer system 310 acts to generate a message, in response to the signal received from sensing unit 307, and send the generated message to display screen 316.

FIG. 1C shows another part of the store, including checkout station 900. Checkout station 900 includes a UPC bar code reader that detects an optical (electromagnetic) signal reflected from a UPC symbol.

Upon completion of shopping, each consumer, including consumer 210, brings selected products from the shelves to checkout station 900.

A consumer such as consumer 210 completes the purchase of his selected products 233 by transferring products 233 from his cart 232 to station 900.

A checkout clerk (not shown), or the consumer, scans each selected product past an RFID sensor, scans each selected product past bar code reader 910, or enters product selection information manually via keyboard 918. As each product is registered, display 917 displays the price of the product. Thus, display 917 displays the price of the can 152 selected by consumer 210.

Checkout station 900 then determines a total amount due and prints the total amount due on display 917 and on the consumer's paper receipt.

Thus, the first exemplary system monitors pre-purchase activity by sensing radio frequency identification (RFID) tags on products in the consumer's shopping basket. Depending on the products in the basket, the system displays a marketing message on a screen, which may be mounted on a product shelf. The marketing message may include suggestions for complimentary or substitutable items.

In this first example, consumer 210 placed a can of tuna 152 in his shopping cart 232. Later, at a different point in the store, sensor 307 detected can 152. Computer 310 receives the RFID signal from sensing devise 307, to generate a display signal for display 316. Display 316 receives the display signal to display a message for consumer 210. The message is a suggestion to buy a certain brand of mayonnaise.

As shown in the first exemplary system, sensing unit 307 may detect a product in a shopping cart when there are plurality of other products in the cart, including products having their own RFID tag.

Computer 310 may also generate a message depending on whether additional products are detected in combination with a first product. Thus, for example, if computer system 310 detects that a shopping cart contains sugar and flour, computer system 310 may send a message to a display related to a baking recipe. In other words, the content of the message generated by computer system 310 may depend on whether a second product has been detected with the first product, or may depend on whether an even more complex combination of products has been detected.

The first preferred system will now be described in more detail.

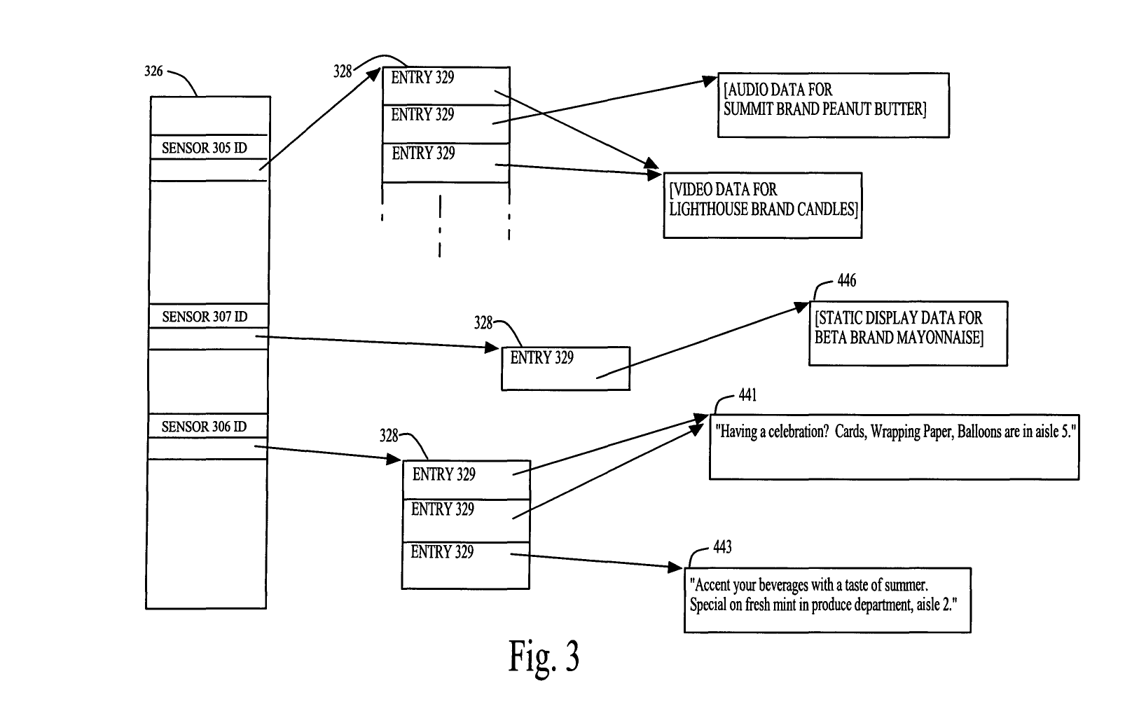

FIG. 3 shows some data structures stored in an electronic memory within computer system 310. When computer 310 receives a signal from a sensing unit, computer 310 uses the ID of the sensing unit to access sensing unit table 326. Each entry in table 326 has two fields. The first field is a sensing unit ID, and the second field is a reference to a display criteria record 328.

In the data structures shown throughout the drawings, lines represent a reference, such as a pointer, between one element and another. These references are not necessarily direct memory address pointers. Instead, more generally, each reference is a data entity, stored in association with one (referencing) element, that enables a processor to find a related (referenced) element. To physically address the referenced element, the processor may subject the reference to various translations or mappings.

Each record 328 has a variable number of entries 329. Each entry 329 includes data for an output device, and criteria for whether the data should be sent to the output device.

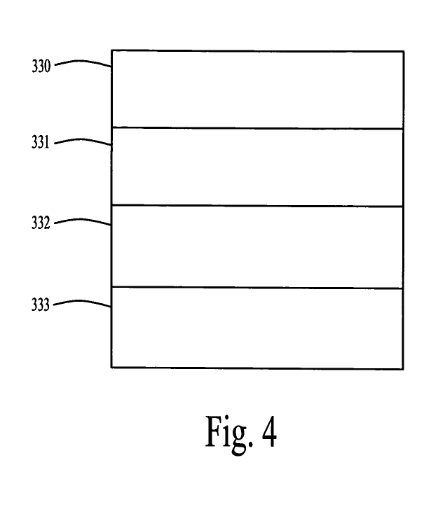

FIG. 4 shows a record entry 329 in more detail. Field 330 is variable length and contains the set of products required for the associated output data 333 to be sent to a device. Field 330 may identify multiple products, only one product, or no products.

Field 331 is a list of products that must not be present in the shopping cart for the associated data to be sent to an output device. Field 331 may contain a list of multiple products, one product, or no products.

Field 332 is the device ID of a device to receive data designated by pointer field 333. In this first exemplary system field 332 will contain the device ID of display screen 315, display screen 316, or display screen 317.

Each record 328 thus includes a general Boolean logic expression, capable of expressing any combination of products. Each entry 329 is essentially an OR term of the expression. Within each entry 329, each product in field 330 is an AND term. Within each entry 329, each product in field 331 is a negated AND term.

Computer 310 essentially includes an evaluator 312 for the logic expression described in the previous paragraph. Evaluator 312 includes a set of instructions sequentially executed by an electronic processor.

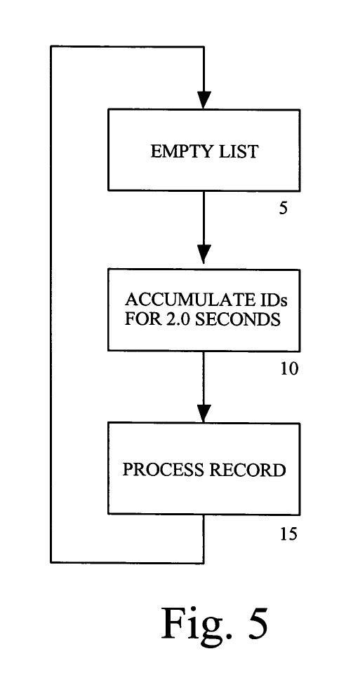

FIG. 5 is a process flow chart for describing building of a sensing record for each sensor unit in the first preferred system. The record includes a list of the RFID(s) detected by the sensor unit during a certain duration, 2.0 seconds for example. System 1 empties the list, by setting a list index to 0 for example. (step 5). For each ID detected by the sensor unit, system 1 adds the ID to the list. (step 10). System 1 performs step 10 for 2.0 seconds. During the performance of step 10, system 1 may cycle through various types, frequencies, or powers of the tag interrogation signals and protocols, to read and distinguish among multiple tags in a shopping cart.

After 2.0 seconds of execution of step 10, system 1 processes the list of IDs (step 15), and then again passes control to step 5.

System 1 includes circuitry to perform the process of FIG. 5 for each sensor unit. This circuitry may include logic in each sensor unit itself, or may include logic distributed between the sensor units and computer 310.

In this Patent Application, the word circuitry encompasses dedicated hardware, and/or programmable hardware, such as a central processing unit (CPU) or reconfigurable logic array, in combination with programming data, such as sequentially fetched CPU instructions in an electronic memory or programming data for a reconfigurable array.

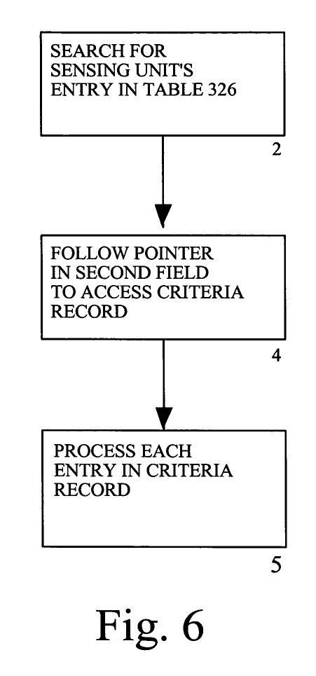

FIG. 6 is a process flow chart for describing step 15 of FIG. 5, the processing of a sensing record. System 1 searches the first field of the entries sensing unit in table 326, to locate the entry associated with the sensing unit of the record. (step 2). System 1 uses the second field of the located entry to access the corresponding display criteria record 328. (step 4). System 1 then processes each entry 329 in the accessed record. (step 5).

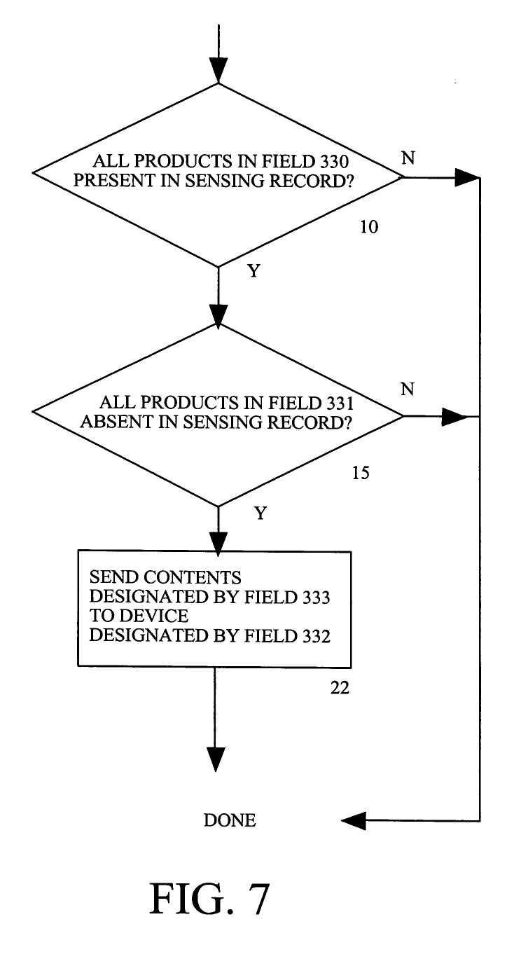

FIG. 7 is a process flow chart for describing a part of step 5 of FIG. 6, the processing of a single entry 329. System 1 determines whether each product in field 220 is also in the sensing record. (step 10). If the result of step 10 is yes, system 1 determines whether each product in field 331 is absent from the sensing record. (step 15). If the result of step 15 is yes, system 1 displays a message for a consumer on an output device. (step 22).

Thus, system 1 detects a product selected by a consumer, and generates a message, a content of the message depending on the product identification code of the detected product. System 1 then displays the message to the consumer. Because this displaying of the message is thus triggered by the detection of the product, a time of occurrence of the displaying depends on a time of occurrence of the product detection.

Another example of operations of the first preferred system will now be described.

Product Area 110 has packages 112 of S Brand sugar grouped together on multiple shelves. Packages 112 are contiguously grouped, meaning that no other product is between any two packages 112. Respective units of packages 112 have a common RFID tag, different from RFID tags on units of other products, that uniquely identifies S Brand Sugar. Respective units of packages 112 have a common visual label, different from visual labels on units of other products, that uniquely identifies S Brand Sugar.

Product Area 160 has packages 162 of Western Brand flour grouped together on multiple shelves. Packages 162 are contiguously grouped, meaning that no other product is between any two packages 162. Respective units of packages 162 have a common RFID tag, different from RFID tags on units of other products, that uniquely identifies Western Brand flour. Respective units of packages 162 have a common visual label, different from visual labels on units of other products, that uniquely identifies Western Brand flour.

Product Area 130 has packages 132 of Store Brand flour grouped together on multiple shelves. Packages 132 are contiguously grouped, meaning that no other product is between any two packages 132. Respective units of packages 132 have a common RFID tag, different from RFID tags on units of other products, that uniquely identifies Store Brand flour. Respective units of packages 132 have a common visual label, different from visual labels on units of other products, that uniquely identifies Store Brand flour.

Product Area 140 has bottles 142 of Tropical Brand lemon extract grouped together on multiple shelves. Bottles 142 are contiguously grouped, meaning that no other product is between any two packages 132. Respective units of bottles 142 have a common RFID tag, different from RFID tags on units of other products, that uniquely identifies Tropical Brand lemon extract. Respective units of bottles 142 have a common visual label, different from visual labels on units of other products, that uniquely identifies Tropical Brand lemon extract.

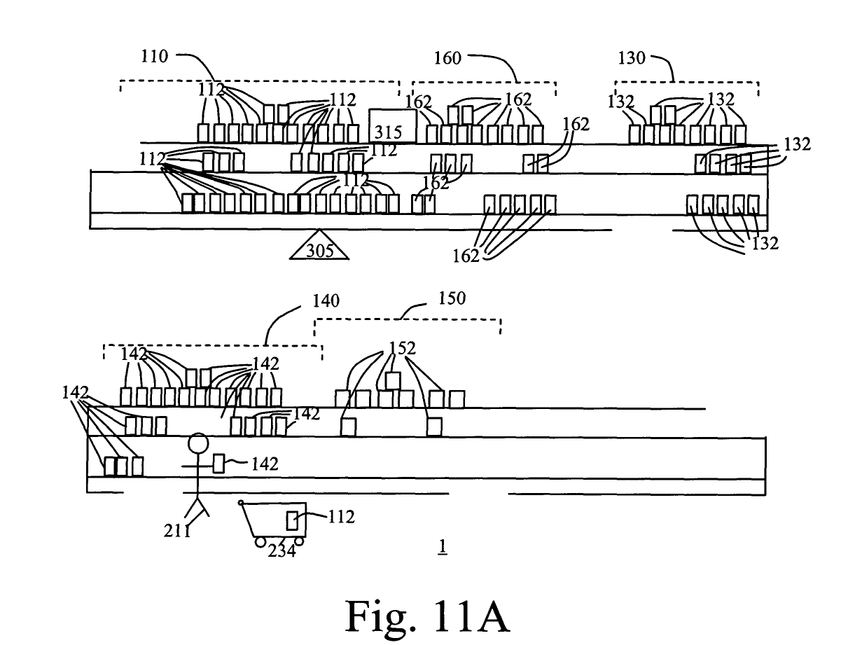

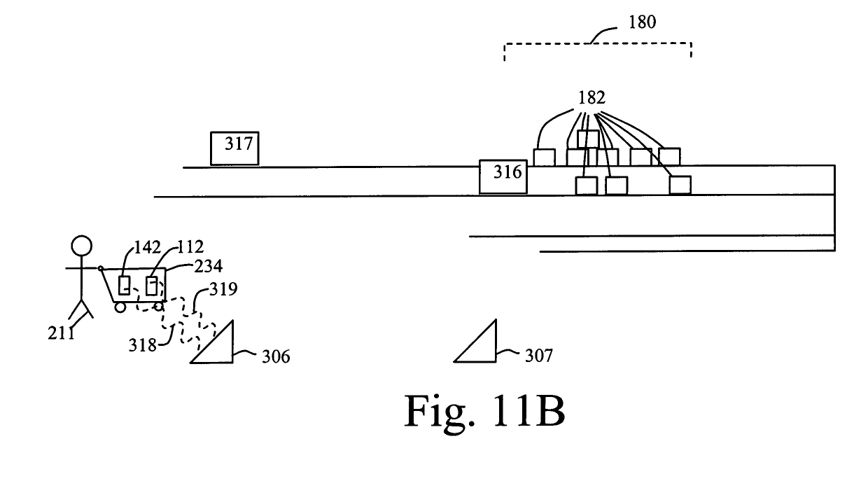

FIG. 11A shows consumer 211 shopping at a certain time at a location in the store. At the time depicted in FIG. 11A, consumer 211 removes a bottle 142 of lemon extract and places the bottle 142 in his shopping cart 234. At a previous time during the same visit to the store, consumer 211 removed a package 112 of sugar and placed the package 112 in his shopping cart 234.

FIG. 11B shows consumer 210 at a later time at a different location in the store. At the time depicted in FIG. 11B, consumer 211 pushes his cart 234 through the detection zone of sensor unit 306. In response, system 1 executes the process described in connection with FIG. 5 above. System 1 initializes record 335 (FIG. 12) stored in an electronic memory with an empty list. (FIG. 5, step 5). Sensor unit 306 detects a radio signal 319, encoding a product ID from an RFID tag on package 112. Thus, system 1 adds the ID for S Brand sugar to record 335 in FIG. 12. (FIG. 5, step 10).

Subsequently, sensor unit 306 detects a radio signal 318, encoding a product ID from an RFID tag on bottle 142. Thus, system 1 adds the ID for Tropical Brand lemon extract to record 335 in FIG. 12. (FIG. 5, step 10).

After 2.0 seconds of executing step 10, system 1 processes record 335. (FIG. 5, step 15). Thus, as outlined in FIG. 6, system 1 locates the third illustrated entry in table 326 of FIG. 3. (FIG. 6, step 2), follows the corresponding pointer the criteria record, (FIG. 6, step 4) and processes each entry in the criteria record. (FIG. 6, step 5). As shown in FIG. 3, the criteria record for sensor unit 306 has 3 entries.

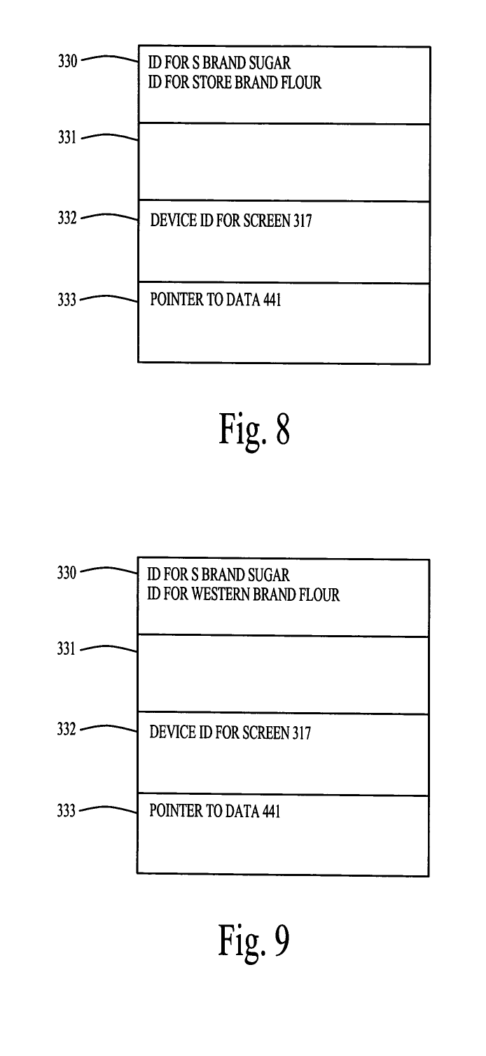

Thus, according to FIG. 6, step 5, system 1 performs the process of FIG. 7 on the first entry 329 (FIG. 8) of the criteria record for sensor 306. Because field 330 contains the ID of Store Brand Flour, but sensing record 335 does not contain the ID of Store Brand flour, the result of FIG. 7 step 10 is no (N), and the processing of the first entry 329 (FIG. 8) is complete.

Subsequently, according to FIG. 6, step 5, system 1 performs the process of FIG. 7 on the second entry 329 (FIG. 9) of the criteria record for sensor 306. Because field 330 contains the ID of Western Brand Flour, but sensing record 335 does not contain the ID of Western Brand flour, the result of FIG. 7 step 10 is no (N), and the processing of the second entry 329 (FIG. 9) is complete.

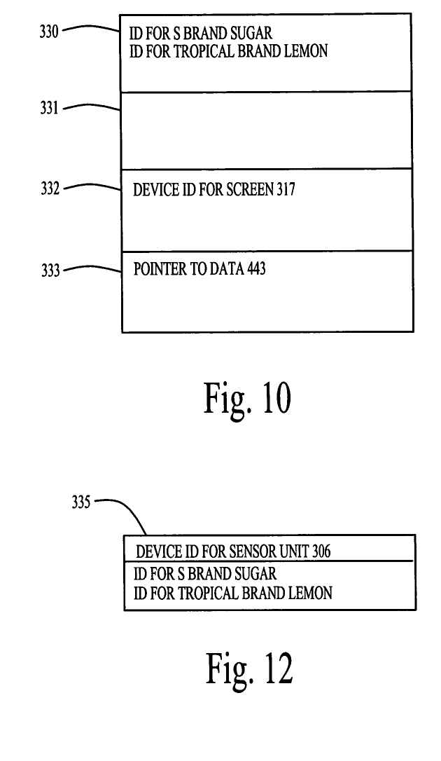

Subsequently, according to FIG. 6, step 5, system 1 performs the process of FIG. 7 on the third entry 329 (FIG. 10) of the criteria record for sensor 306. Because sensing record 335 contains the IDs of both S Brand sugar and Tropical Brand lemon (all the products in field 330), the result of FIG. 7 step 10 is yes (Y), and processing proceeds to step 15 of FIG. 7.

Because field 331 (FIG. 10) is empty, the result of FIG. 7 step 15 is yes (Y), and processing proceeds to step 22 of FIG. 7. Thus, system 1 send a signal to display screen 317. The signal includes the text of record 443, displayed for viewing by customer 211. “Accent your beverages with a taste of summer. Special on fresh mint in produce department, aisle 2.”

Thus, system 1 may also be configured to detect a set of product(s) selected by a consumer, and generate a message depending on the product identification code(s) of the detected product.

According to another optimization, a content of the message may depend on a history, demographic, or profile record for the consumer. Contents of the history, demographic, or profile record may result from the customer's behavior on a previous day.

Second Preferred Embodiment

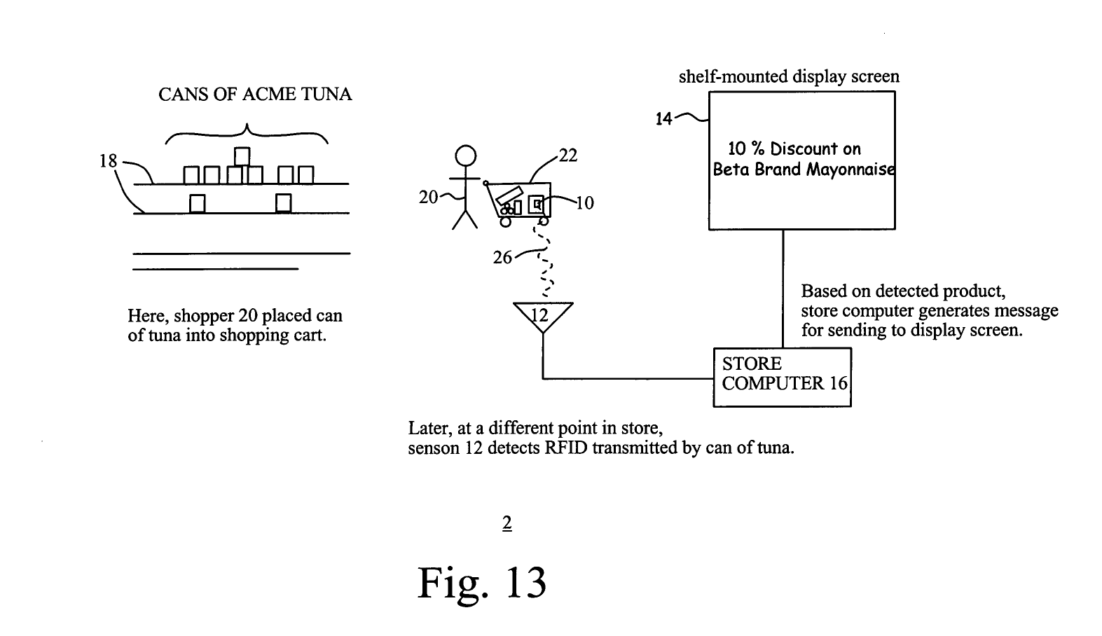

FIG. 13 is a diagram showing a store of a retail system 2 in accordance with a second preferred embodiment of the present invention. Shopper 20, in an aisle, is viewing a display message activated by the sensing of the collection of items in a basket. A radio frequency identification (RFID) tag 10 attached to a product and is selected from products interrogated by a RFID Sensor Reader 12 located through the store and in communication with sensory output devices such as LCD Display 14 and controlled by a display driver providing content and information from a computer 16 that may be located in the store. The LCD Display 14 is typically located near products arranged on the shelves 18 of a supermarket aisle gondola for viewing and selection by a shopper 20 that may be using a hand basket or shopping cart 22 while moving through the store selecting, or not selecting, items for purchase, and able to receive sensory output to influence purchase decisions while in the store environment.

The second preferred embodiment has all the functionality of the first preferred embodiment, interrelated with the additional functionality and additional structure described below. Thus, the second preferred embodiment has all the functionality of the first preferred embodiment, in addition to the functionality described below.

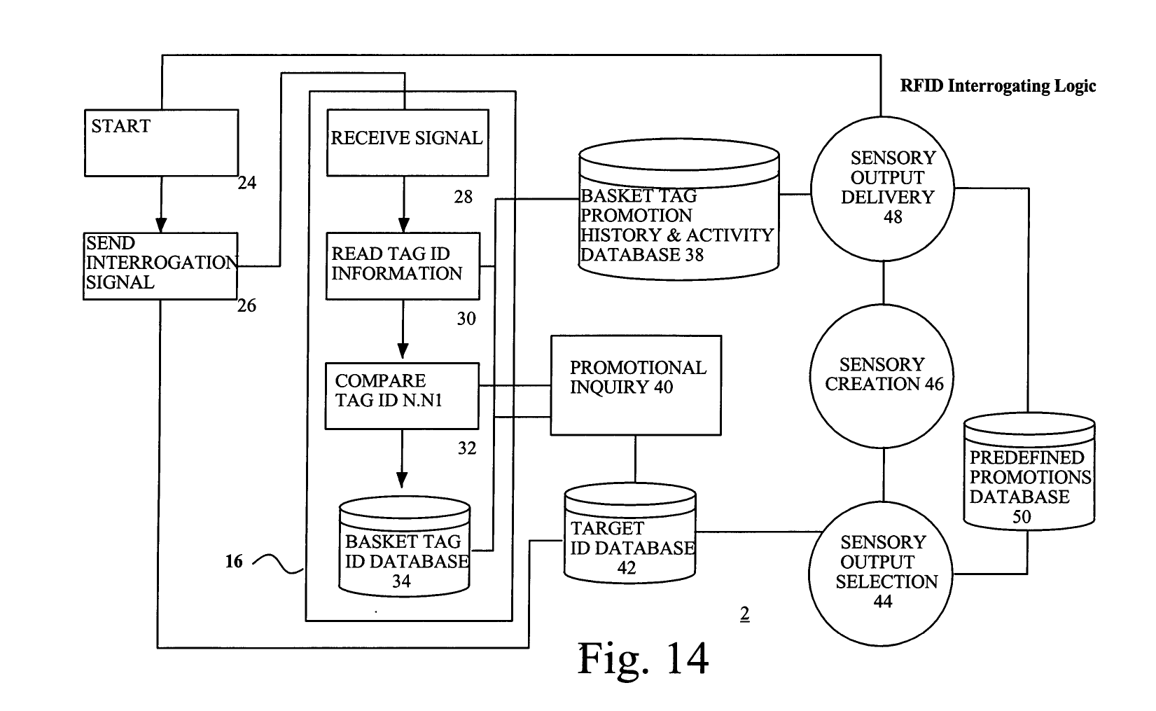

FIG. 14 is a diagram emphasizing other aspects of system 2 of the second preferred embodiment. FIG. 14 shows processes constituting the tag sensing and display process in system 2. The RFID sensor initiates the flow (process 24) to send an interrogation signal (process 26) seeking to find, read or interpret the RFID tag signal(s). The received RFID signal (process 28) is then read for information (process 30). Subsequently, a tag identification is compared (process 32) with known tags 34 targeted for promotional inquiry process 40 from all of the desired ones in target ID database 42. This process may take place in the computer 16 in the store.

Computer 16 reads the tag for information (process 30). Computer 16 sends detail to a basket tag history and activity database 38 to record activity of the shopping activity, as each item is added to the shoppers database the ability to have each shoppers trip characterized by the foot print path and item with RFID tag 10 are aggregated and as each item is added or recognized for each distinguishable shopper 20 is able to be tracked for promotional inquiry process 34 based upon target ID database 42 of items or arrays of items that are eligible for a sensory output signal such as one sent to a LCD Display 14 after the promotional inquiry 40 processing step has taken place and the Target ID database 42 has been searched for a match.

When there is a match, there is the decision process for the selection of the type of Sensory Output Selection 44 and then the Sensory Creation 46 of the sound, images and information to be sent for sensory output delivery 48, which may be audio or visual in the case of the LCD Display 14 that is used to send images of text and or graphics, video, and or some other type of sensory stimulation.

The Sensory Output Selection 44 process is improved over time as each offer and or promotional effort is delivered, in an effort to learn to identify useful patterns from shopping trip activities as the shopper 20 builds their collection of RFID tag 10 items and products into the cart or basket as they go through the store.

In cases where the shopper 20 and/or cart is distinguishable and or identifiable using a machine readable input such as RFID tag built into the cart, basket or shopper 20 identification card for loyalty or payment additional predefined promotions database 50 may be accessible in addition to the predefined promotions database 50 being searched for promotions or sensory out based upon product RFID tag 10 codes that are searchable for appropriate sensory output delivery 48 to LCD Display 14 located near the products on the shelves 18.

The promotional inquiry process 40 searches the basket tag history and activity database 38 for changes and comparisons of the various shoppers collection of RFID tag 10 merchandise. As each shopper 20 moves through the store the activity is recordable, the amount of time the shopper 20 expends during the selection, rejection and comparisons effort of each RFID tag 10 items and among the items.

Knowing what type of items are reviewed, selected and rejected, the order of the process and pattern of the shopper 20 route in the store assist the retailer in better designing the store's product mix on the shelves 18 and location in the store. Good stocking, supply and re-stocking efforts are possible when real-time selection data is known.

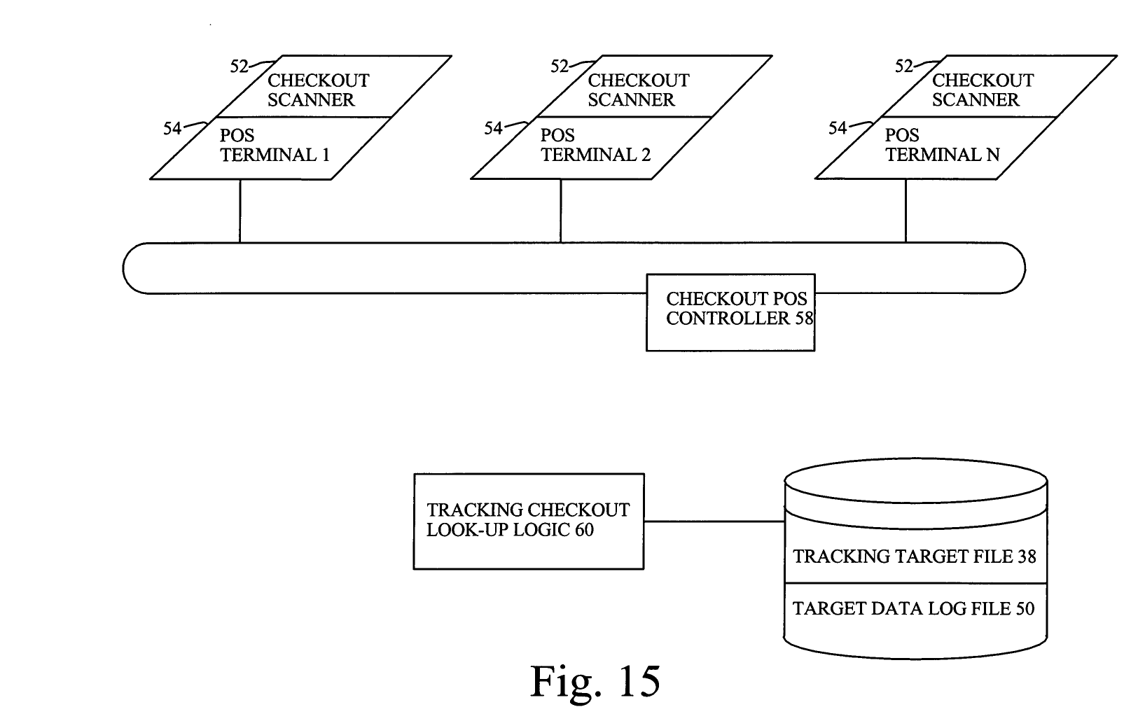

FIG. 15 shows the relationship of the tag reading and traditional checkout Point of Sale (POS) terminals and targeting database of product RFID tags. In the process of shopping, the terminus point is reached when the tender key is pressed and payment made for items. When the shopper 20 reaches the point after selection they will have the item go through a Check out scanner 52 that passes the information through to a POS terminal 54. These may be conventional bar code scanners adapted to perform a interrogation signal 26 for RFID tag 10 goods. As items are scanned for purchase it is typical that this activity takes places in the store's “front end.” The check out scanner 52 and POS terminal 54 are connected and pass data and information on a store network 56 to a merchant's checkout POS controller 58.

Prior art technology has relied upon inserting messages in between the check out scanner 52 and POS terminal 54 via the store network 56 and checkout POS controller 58. The present system may cooperate with these messages but does not require such access.

The system and method seeks to promote before the shopper makes a final purchase and leaves the store. There may be a connection to the present system that seeks to have tracking check out look-up logic 60 searching basket tag history and activity database 38 and predefined promotions database 50 for any additional offers and to finalize the basket profile for historical file record keeping. Whether or not the shopper 20 is identifiable, the shopping event history is at least distinguishable based upon the data elements collected during the trip such as time, items reviewed, items influenced for promotion by sensory output or those items purchased with or without a sensory output delivery 48. This data is may be useful to marketing of products for the manufacturer and retailer. Shelf space assortment and stocking levels are now able to be more dynamically configured instead of the traditional cycle of yearly planning and resetting of the items on the shelves 18. A more efficient and consumer selection driven process is achievable using this exemplary system and method.

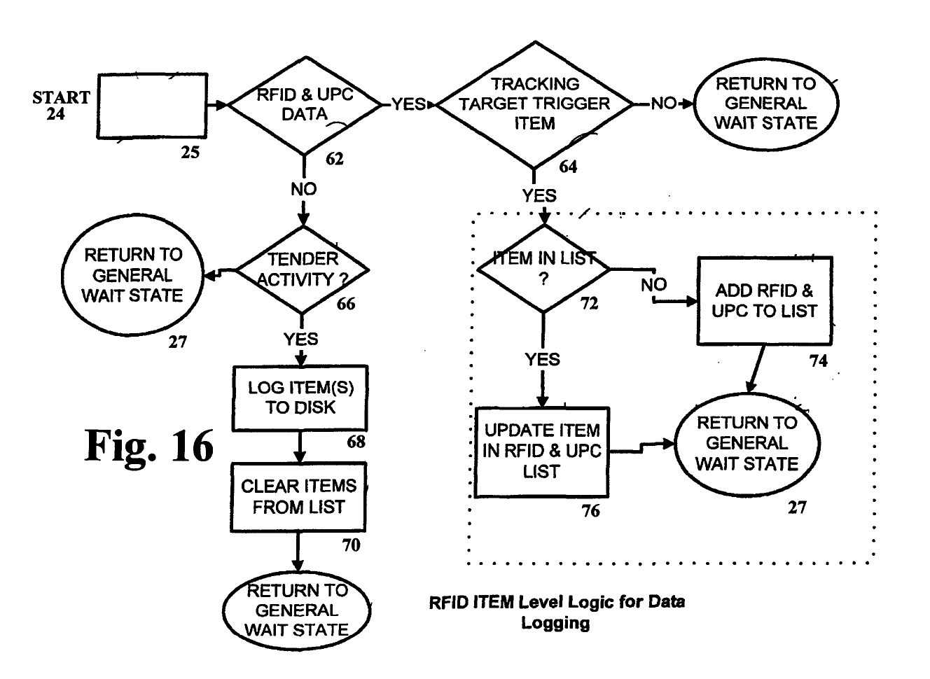

FIG. 16 shows logic of building item(s) read by the sensors and the UPC Universal Product Codes and or SKU Stock Keeping Units relating to the RFID codes. When the sensor starts up 24 and an interrogation signal 26 is sent out, the received RFID signal 28 provides the input 25 to process the read for information 30 so that it can be tag identification is compared 32. During this process the RFID & UPC Data is processed (step 62) and when the promotional data is compared, it is often matched to a product(s) or family of product codes or against a pre-defined set of items in an array or table for tracking and Target Trigger item (step 64) or item(s) when there are no RFID & UPC Data is processed 62 no and matches result and there has been tender activity (step 66) the processing Return to General Wait State 27 while new inputs are required to start the promotional offering targeting and matching process. After the tender activity 66 the items are logged to a file 68, in this case to a disk, once the items are logged the function is to clear the items from the current shopping cart list as the clear items from list function 70 takes place and the logic again Return to General Wait State 27 awaiting more list building and logging of activity. When there are no tracking and Target Trigger item 64 activity the process Return to General Wait State 27. When there are tracking and Target Trigger item 64 the items are compared in a process to those items in the list 72 or in this case predefined promotions database 50 and these matched items are combined in list with the data fields from the RFID tag 10 items, the shopping activity events and add RFID & UPC to list 74 and then the list is used to build a file for the basket tag history and activity database 38. When no more items are added the list is complete for that record and the process Return to General Wait State 27. As each item is added the UPDATE ITEM IN RFID & UPC LIST function 76 continues and when exhausted of items the process Return to General Wait State 27.

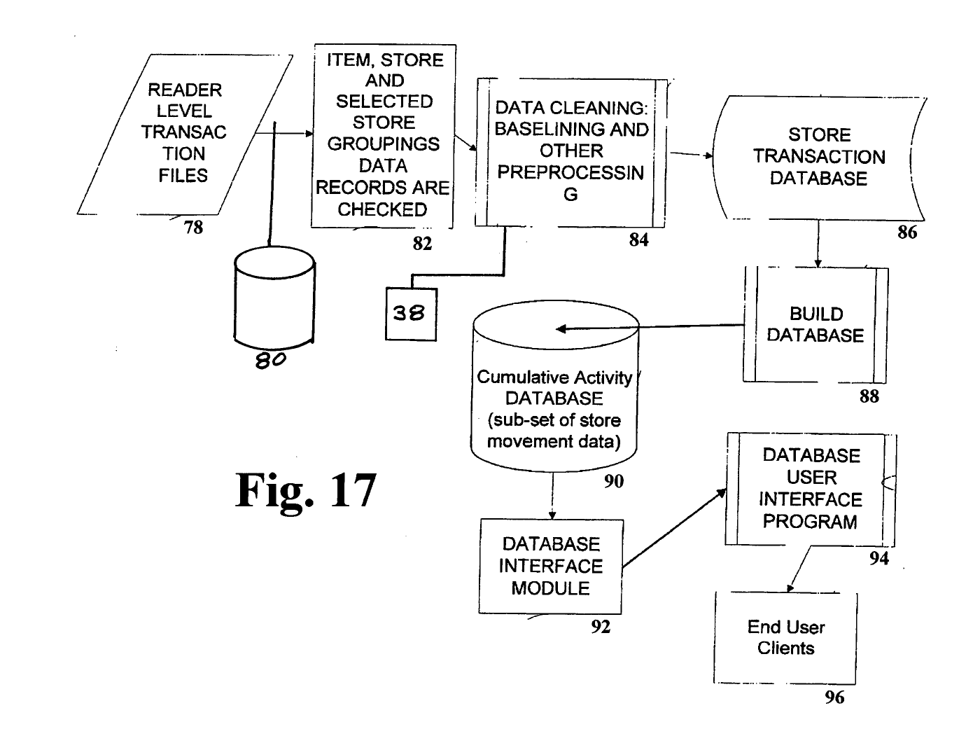

FIG. 17 is a flowchart of the process of building a database of store level transactions for a cumulative activity of the items sold or movement. Using a reader level transaction file 78 which is a collection of all items that the check out scanner 52 POS terminal 54 checkout and POS controller 58 have recorded as sold or purchased items this transaction log 80 for each store(s) are then collected into a database that stores the RFID TAG information, UPC information, SKU (stock keeping unit for each item, store and or selected store groupings and checked for accuracy and able to be compared against basket tag history and activity database 38, the item store and selected store groupings data checking 82 functions to provide analyses of the items reviewed, compared, selected, rejected or substituted during the shopping event by he shopper 20 and activity and performance of the predefined promotions database 50 results are now possible to be reviewed. What behaviors resulted by promotion or non-promotion in store is measurable and trackable. Inference and causal data is able to be empirically measured and tested in a census method. Out of stock analyses is able to be understood in terms of promotional, pricing and selection process level, the point of decision by consumers. The item store and selected store groupings data checking 82 and other databases of transactions and history go through steps for Data Cleaning 84 and other processing and a Store Transaction and Activity Database process takes place to build a combined and store(s) aggregated database build function 88 and a Cumulative Activity Database 90 is built contains the elements of the RFID tag, UPC, SKU and other relevant collected elements in the process and the Cumulative Activity Database 90 is accessible through a Database Interface 92 and Database Interface Program 94 to interested and appropriate End Users 96 that consist of manufacturers, retailers, along with those that function as data research and optimization participants.

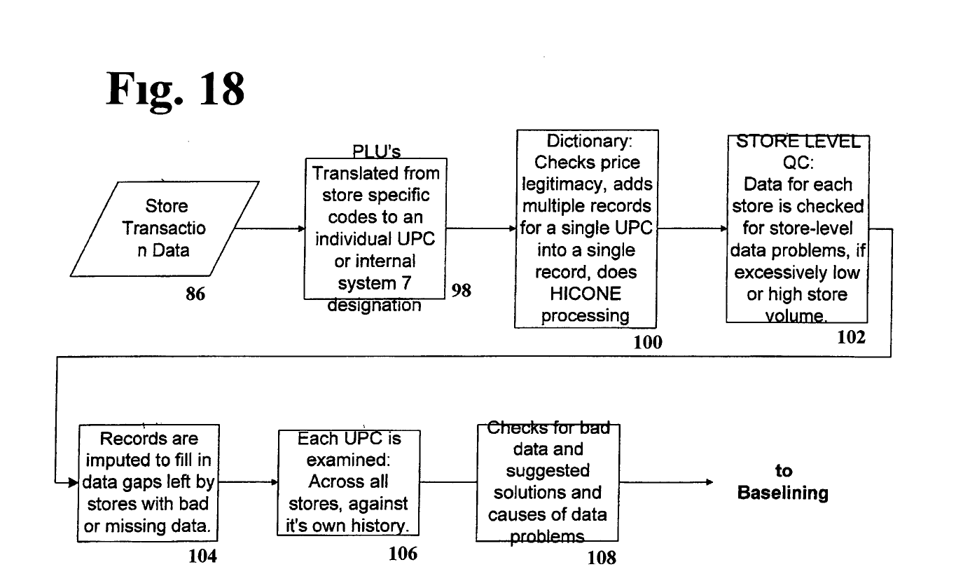

FIG. 18 shows a flowchart of the RFID tag information being processed for relation to known UPC codes and building the baseline of activity for a product(s) of interest for retailers and manufacturers in terms of characteristics of the products selling features, such as flavor, quantity and size. The Store Transaction and Activity Database 86 will contain many items that may not have RFID tags but are sold by a merchant but have bar codes, or PLU codes (Price Look Up Codes) and random weight type of items from the deli or seasonal items or re-redemption deposits for cans and bottles etc these items need translated from store specific codes to the appropriate UPC or store internal system 7 type designation as well as any recorded promotional transactions included in the store purchase log transaction log 80 as it would include coupons, discounts and awards for each order. It is preferred that this information be understood when pre-purchase and post purchase promotional and pricing changes are offered to influence purchasing behavior, each element in the database may have a causal influence that needs to be statistically understood. Translation of items to UPC or other code 98 takes place then the database records are compared and processed with a Dictionary of other checks for price, and unit of measure consistency and HICONE packaging, measuring one unit incorrectly. For example one six pack of a beverage has one product code and it may ring up as either a six pack or an individual can, the unit price and quantity checks need to sort out any of these or other errors in building transaction activity and aggregating across more than one store(s) system and files. The dictionary function 100 corrects and or removes inaccurate data or duplicate activity to have clean reliable data to make reliable correlations and statistical analyses. Store level data is further checked for unusual or activity, the STORE LEVEL QC 102, again the intent of the additional processing is to be certain that accurate comparisons and analyses is possible for the inclusion and understanding of pre and post purchase activity comparisons.

An imputed data element step 104 and Item UPC movement History 106 step is further added and then Problem Suggestion 108 in the processing takes place prior to the data being deposited into a baseling function or into a Cumulative Activity Database 90.

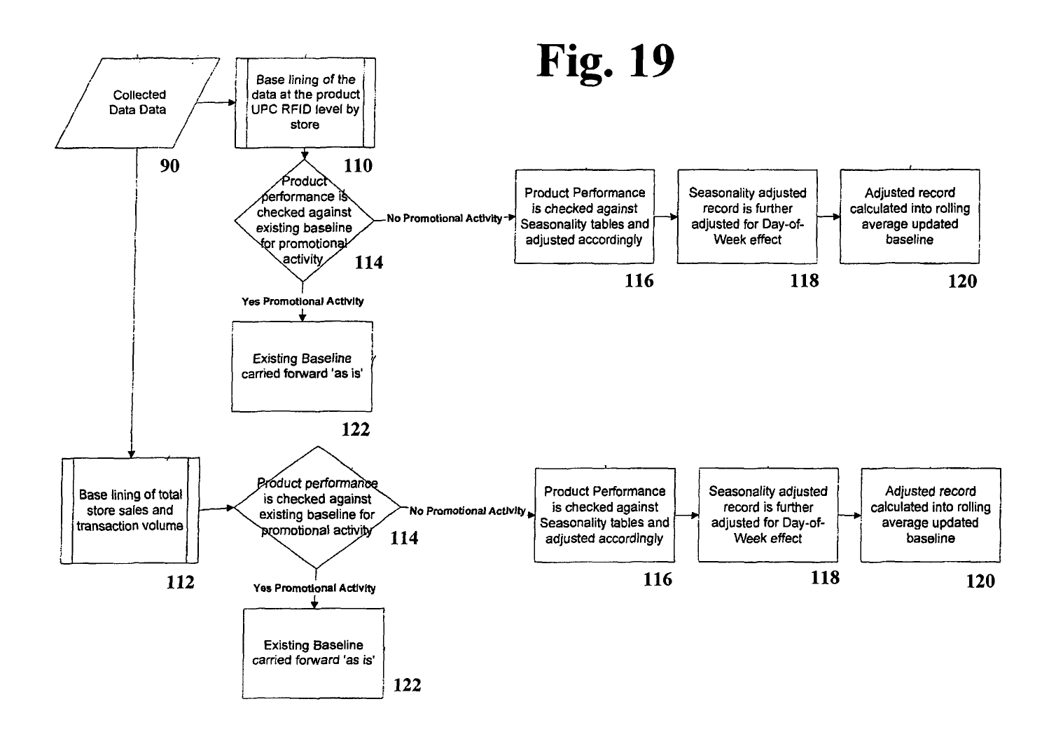

FIG. 19 is a flow chart of the process of baseline performance and promotional activity decisions and influencing measurement. The Cumulative Activity Database 90 is then processed for base lining of the data at the product UPC RFID level by store, store item base lining 110 and it is also processed into total store sales base lining 112 and then checked for promotional activity or no promotional activity check 114 where the item does not show any promotional activity or having been triggered by a promotional inquiry 40 as a result of an promotional inquiry process 34 or Sensory Output Selection 44 and other variables such as Seasonality tables and adjusted accordingly in a Product performance check 116 in addition the Seasonality and sensory output delivery 48 file is checked in the Season & Sensory check 118 then any adjusted recorded to the adjusted record to baseline check 120, where there is promotional activity the Existing Base line is carried forward as is with the indication of the promotional activity record and information as is into the updated database record for base lining in the Carry Forward step 122.

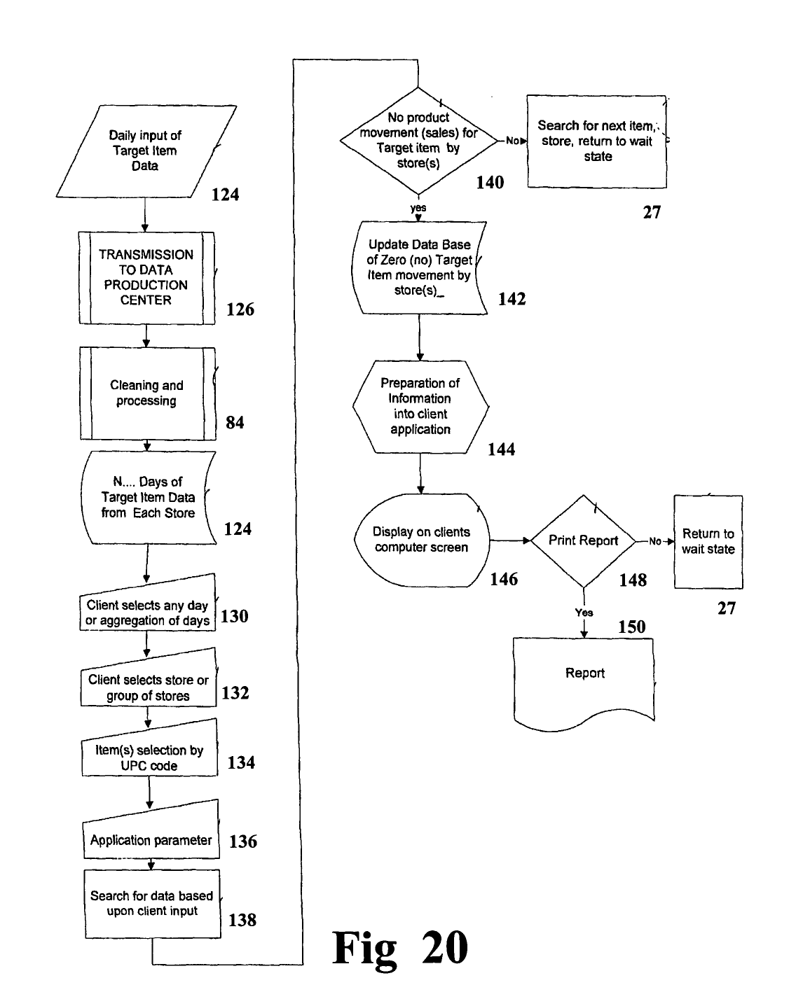

FIG. 20 is a flowchart of the process of building reports based upon client desires. The product items of interest have RFID tag 10 and UPC, PLU, SKU and or other identifying fields and are related to the RFID item record as fields in a database that forms the basis for creating the items or the array of items of interest that become the target item data element of interest. Each stakeholder in the process of manufacturing, selling, promoting, stocking and distribution any item has their own internal stock or identifying number, the RFID tag 10 database helps to tie each of the together because each particular item is registered with the issuing body for RFID tag 10 article numbering, each item, case, pallet and shipment information maybe recorded on the tags. Source, production lot and shipment, transit, inventory and all other functions read the RFID tag 10 and it is related to the correct item entered into the RFID tag 10 database when the item is registered. To be useful to each stakeholder, it is preferred that all of the information be visible and known in there own terms of trade. For example having the RFID tag 10 information as a numerical or hexadecimal read out would mean very little to the person buying, stocking ordering or manufacturing so a table that looks up or relates the RFID tag 10 to other users common knowledge is very helpful. When some desires to set an item to trigger a promotional inquiry on an inquiry basis or to set one up or to do an ad hoc report of an promotional inquiry 40 and eventual Sensory Output Selection 44 on a LCD Display 14 in a store they would need to enter or have the resultant Target Item Data 124 and this data is transmitted to a data production center 126 or function in an application program with an interface to the disclosed system. Several steps take place to perform a elements of data cleaning and processing as in the Data Cleaning 84 steps disclosed then the number of days or time element of interest for each item and store database 128 is built so that a stakeholder or client is able to select the time period aggregation level 130 then the store or stores are selected in the store aggregation step 132 and then the RFID, UPC in a code check select step 134 and then any specific application parameter 136 such as for any optimization of inventory price relationships, promotion price, mix selection and array of product influences, correlations or stocking level analyses, etc. in the application parameter step 138 then the output would indicate either there was no product sales for the target item or there were sales, in the movement decision 140 if no sales the search for the next target item takes place or a Return to General Wait State 27 occurs. When there is no product movement the database of Zero Movement 142 then there is a step to prep the file for any client application interface 144, for example the data may need to be reformatted or sent via a web page or web server to a proprietary stakeholder client software application. Then there is the ability to display results on a stakeholder or client CRT 146 and or a report is printable in a print step 148 and if no print then a Return to General Wait State 27 in the process.

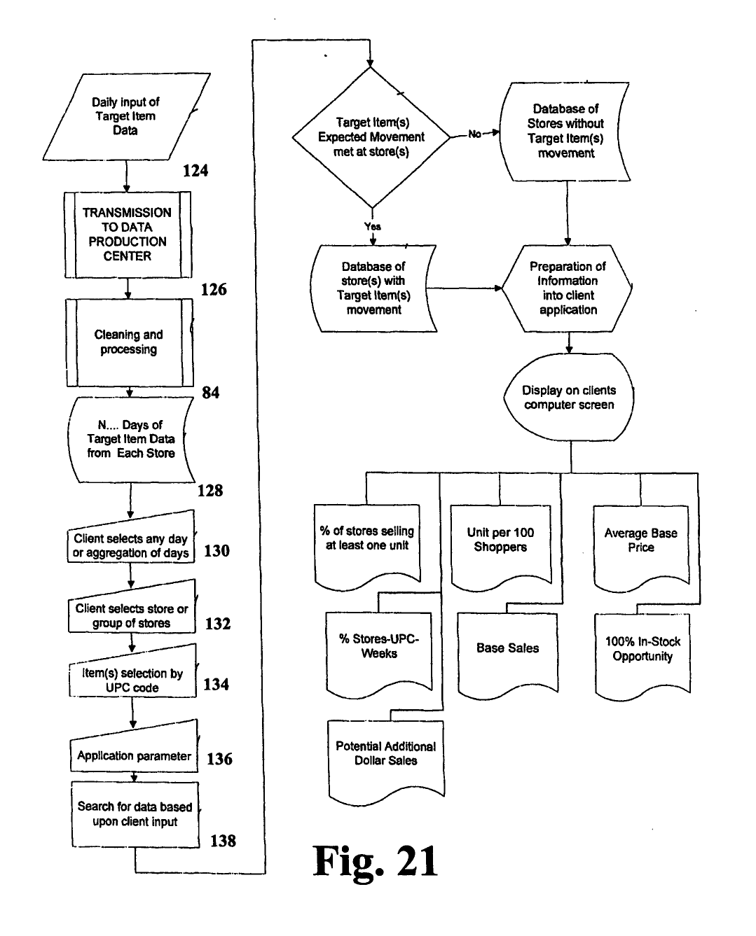

FIG. 21 is a flowchart of the process of understanding and reporting stock status, promotional response, factitively and measurement.

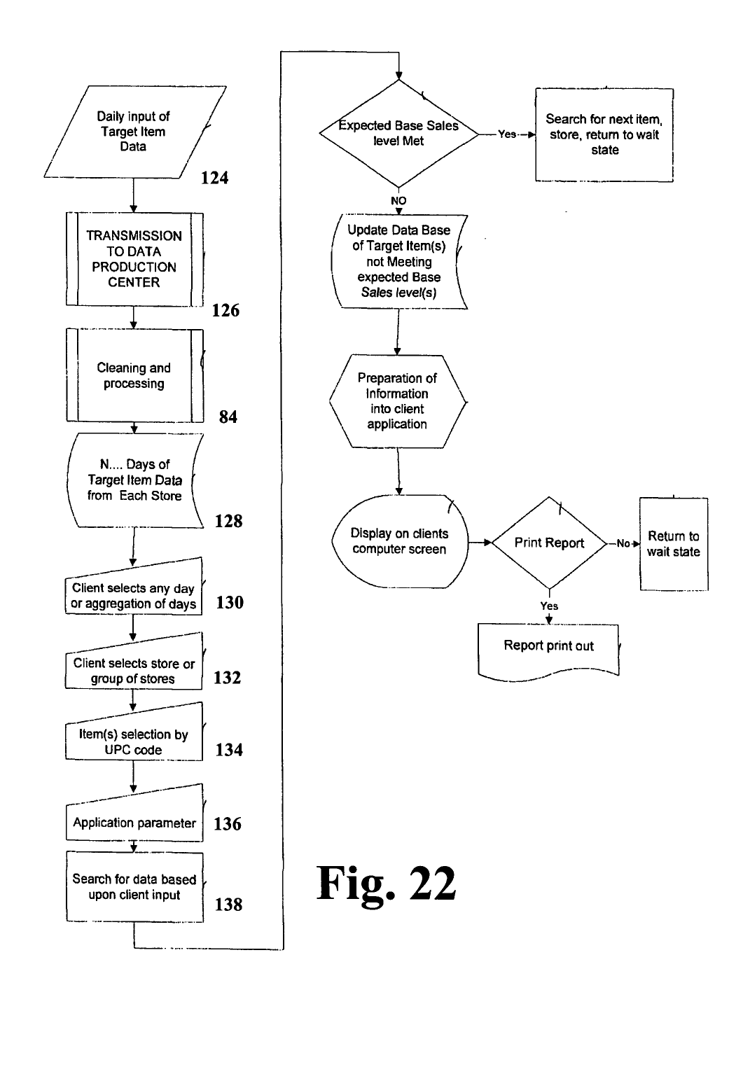

FIG. 22 shows the process of measuring and reporting base sales and activity of the promotional process.

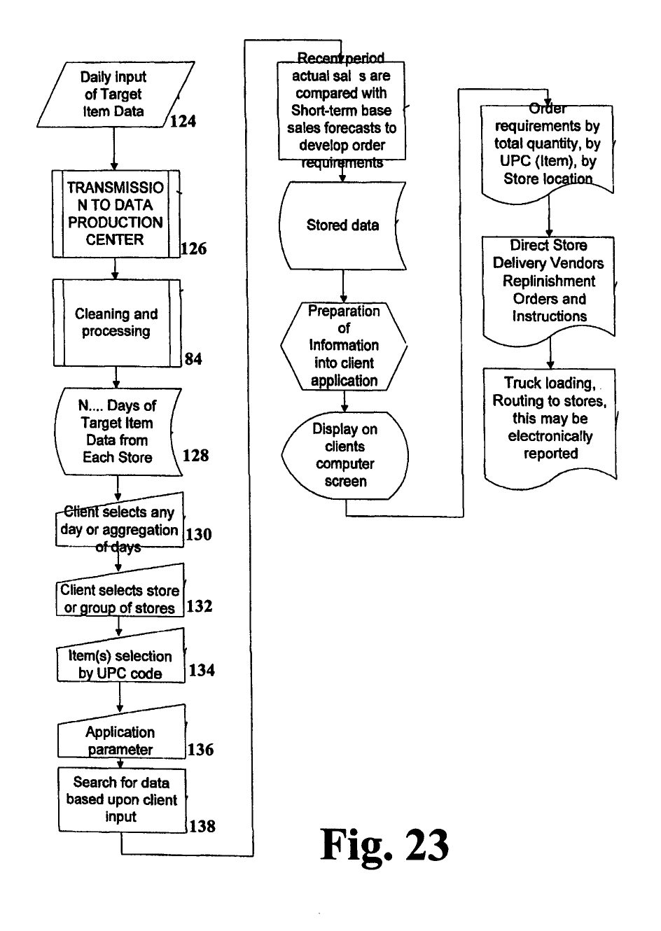

FIG. 23 is a flowchart of the process of directing the replenishment based upon promotional activity.

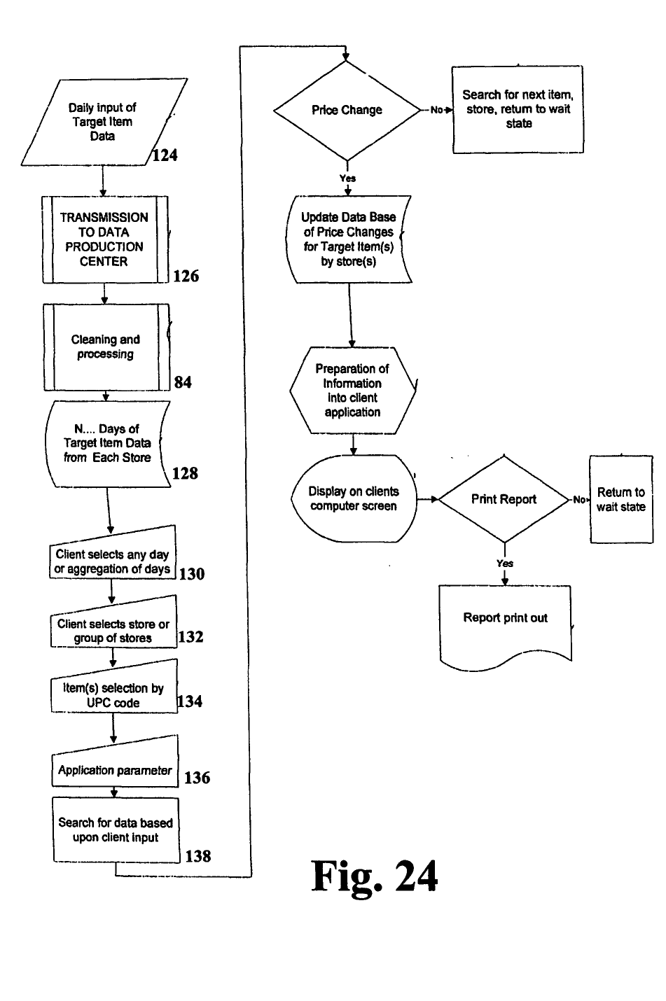

FIG. 24 is a flowchart of the process of reporting the influence of promotional activity that offers a change in price or temporary change in price.

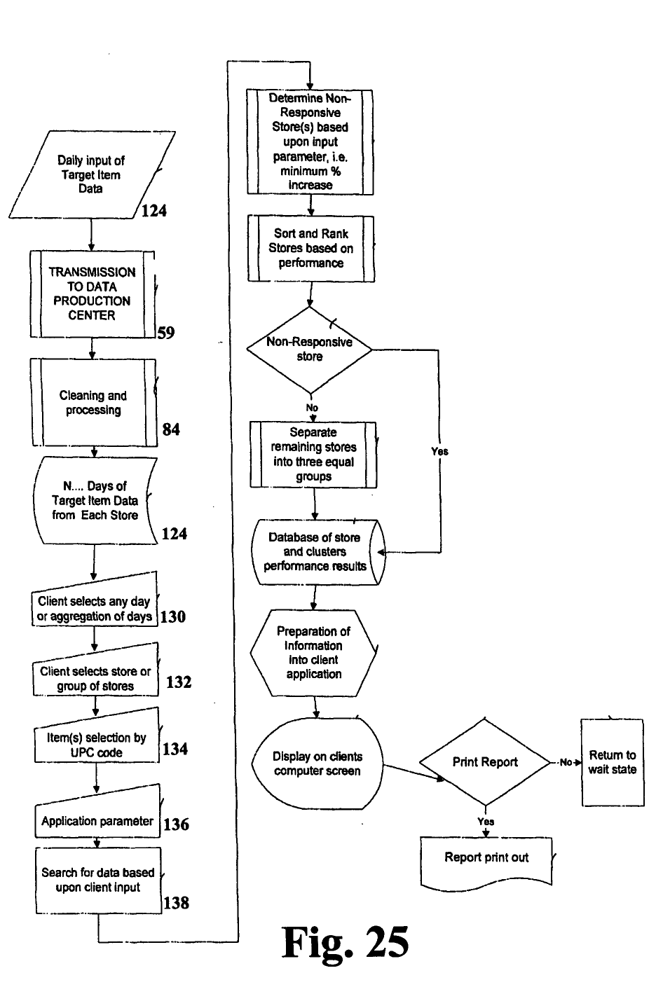

FIG. 25 is a flowchart of the reporting process of the promotional activity by store.

System 2 includes a table of the product identification from RFID, UPC, PLU and related image data and promotional data, text and or other information.

Second Preferred Embodiment—Operation

The RFID tag 10 on a product has a RFID Sensor Reader 12 sense an items presence as being in a location other than the original or appropriate stocking location such as on a shelves 18 in a store or in the hands of a shopper 20 and the activity is sent to computer 16 once the sensor starts up 24 and sees the input 25 from the interrogation signal 26 and this starts the process of received RFID signal 28 as an element in a database of the read for information 30 from the tag identification is compared 32 being compared to known RFID tag 10 in the store inventory or the master RFID tag 10 registry of the issuing body of RFID tag 10 data.

The data is entered into databases tracked and base lined so that meaningful comparisons based upon data elements collected such as time of day, day of week, month year, quantity size, flavor, and the items that were selected or inferred as considered or already purchased or the order of aggregation in the basket for checkout were or were not influenced by a sensory output or other variables in combination or without being promoted by a Sensory Output Selection 44 and then sensory output delivery 48 to a devices such as a LCD Display 14 to be observed by the shopper 20 during a shopping event.

Thus, system 2 provides processes for sensing RFID or other machine readable item tag past a sensor and or position in a retail space, in or around sensors with the ability to interrogate the products within a shopping basket or items being considered for purchase by a consumer during a shopping trip and also having the ability to track the location, selection, rejection and accumulation of an array of products and the ability to analyze and present information to the shopper such as complimentary items and either other items or items of an anomalous nature presenting promotional or relevant selection influencing information to proactively influence purchasing behavior with audio, visual stimuli that is directed towards the individual during the shopping experience.

The ability to track activity and the rate, type and style of selection and aggregation of items during the trip of a shopper 20 allows for optimization analyses technology to have until now the data described to further improve price, selection, availability and product characteristics matched to locations and improve promotional targeting. The system permits the collection of additional data elements that have until now been a long felt but unmet need. The selection process has been without the census data collection of consumer in store behavior that the system provides.

System 2 may record or process:

1. Order of RFID marked item(s) or lack of item(s) considered, collected and or for purchase.

2. Sequence of RFID marked s) or lack of item(s) considered, collected and or for purchase.

3. Array of RFID marked item(s) or lack of item(s) considered, collected and or for purchase.

4. Grouping of RFID marked item(s) or lack of item(s) considered, collected and or for purchase.

The order, sequence, array and groupings of products being selected or rejected during the consideration and selection process during a shopping experience and process are useful for marketing, sales and manufacturing organizations. Knowing what is being considered at what point in the shopping trip and what other items were selected and or rejected and ultimately purchased provides insight into consumer motivation. The influence and resulting reactions and or responses to marketing messages displayed assists professionals in understanding consumer behavior, attitudes, and priorities for products based upon what is or is not communicated or presented to the shopper.

Specifically the price and non-price influences are important to understand for everyone involved in the promotion, distribution and sales of consumer products. For example knowing the order, the sequence that each item is selected in the shopping experience and being able to sense and or record the process of accumulating items for final purchase provides useful data for causal and statistical analysis. When consumers are shopping the reaction to what items are offered, where they are offered and at what price point relative to other items during the shopping experience can be evaluated. In a grocery store re-locating items from a traditionally location, for example condiments from shelves with all other condiments such as ketchup, mustard and relish to say the bread aisle shelf location with or near hot dog buns may seem logical, but can be tested when the order and selection process is able to be tracked because of each item being identifiable through RFID tags and as they are added to the shopping basket. Moving items from one location to another is well known to have a positive or negative effect for specific items. But, in the past, developing new locations and combinations of display for products was done by trial and error.

With system 2, new locations and combinations of promotional items and price changes can be better understood. For example having items stacked on an end of an aisle, also known as an end cap display, increases the amount of items sold over the regular shelf location. Product manufactures pay a premium to be located on a shelf aisle end cap. Manufacturers will pay cash and or offer incentive terms to have their products displayed in this manner. Manufactures also would like a method to verify that the product has been displayed as contracted. An increase in volume is expected and is often the only way know to indicate the display was set up. Having RFID tagged products and the accumulation data would provide an indication that the display was set as desired. Consumer have become conditioned that the end cap is a promoted item and often will select the item, in greater quantities and often believe the item is on discount. So where you locate a product from its typical store category location is now measurable with RFID tagged items and displays sensing and emitting messages while accumulating these data points.

Knowing the order of and the category of items purchased during the trip is useful, for example to people shop the store from produce to meat, deli items or do they shop warm items, cold, then frozen when loading a basket, is there order or is it random? System 2 is able to help answer store shopping layout and habits of all shoppers and not just observing a few shoppers.

Manufactures would like to understand price elasticity to price, volume and or quantity of their products. Knowing the order an item was purchased and the location in the store and what was done by the consumer in response to an advertisement from a display in the store and know the best price point for a given marketing area, time of day, day of week etc.

Knowing the order, of items purchased assists with improving the layout of the stores physical location of items for consumers. Many stores often locate items in such a manner to force shoppers to walk past other items, that are not as frequently purchased, hopping to increase the purchase frequency of the less often purchased items. Specifically the milk and eggs and bread are often located on back side or far perimeters of the store so that a consumer must walk to the back of the store, past many other items.

The most frequently purchased items are scattered to drive traffic to other low traffic points of the store. Using system 2, new store layouts can be tested to see if they yield different amounts of sales of high and low volume items in the new configuration. Having the store laid out to make it more convenient or acceptable for customers is a time consuming process, but using system 2 new configurations can be tested and compared quickly as the items order; sequence and array are traceable and measurable.

Retailers are often reluctant to change a layout or item location for fear of upsetting customers as they have become accustomed to a store layout. So any suggestion of repositioning or changing a shelf facing is difficult without good empirical data that system 2 is capable of supplying.

The array of items in a basket and how they are built is important as a system 2 may be configured to sense a missing item that is typically purchased in combination with other items. For example a shopper may be collecting items for baking a cake and each incremental take the artificial intelligent systems one item closer to making a relevant suggestion that may or may not be obvious to suggest. With the cake baking, there may be a suggestion for birthday cards, candles or appropriate beverage to celebrate. Sensing a birthday card the candles maybe suggested along with frosting. Frosting selected first may prompt the display to suggest a card. The array and order of items provides valuable marketing insight and subsequently promotional messages output on the visual signage in the store.

Groupings of items may suggest a stocking up trip, pantry loading by the shopper. Additional staples such as large bags of salt, flour and items are appropriate to promote. The groupings of items may suggest a BBQ, hot dogs, buns, beet etc. Other relevant and common items such as general merchandise may be promoted, for example ICE, ICE chests and bottle openers on the in store Signage. Contextual and appropriate and unusual groupings can be learned over time and promote highly correlated but possible unrelated items to increase sales and consumptions of items offered by the retailer. System 2 may observe unusual and unforeseen combinations, as the order of selection and rejection are better understood. Some items may be selected for price than returned to the shelves as another more or less expensive item is selected instead. Knowing the acceptable array of an item and or brands is useful as a brand learns which competitive item, product or brand is selected and under what circumstances. All of the selecting based upon price and promotional messages can be observed using system 2 and more optimal pricing and promotion messages delivered to influence consumers.

Knowing that a product is usually purchased with another product, peanut butter and jelly spread can be used to assist the marketing of complimentary items. Knowing that an item has not been selected provides an opportunity to send a promotional message. Knowing that people typically purchase x, y and z is important when formulating a predictable message and promotion. During the shopping trip the promotional message is most valuable not after the trip. Less then a fraction of 1% of the shoppers will return and get an item after beginning the checkout process. Using system 2 understanding order, sequence, array and grouping of items as they are accumulated opens new and useful understanding of new, long felt and unmet needs for promotional opportunities.

Making prediction of the next item purchased is only possible if the sequence, order is comparable to other known arrays and grouping of items selected before purchase. There are enormous amounts of post purchase basket studies and technique but nothing such as system 2 using the RFID process to map and track the basket of items as it is being collected.

The shopper 20 may select an item and later reject the item and leave it in a different location and system 2 can track these items for efficient restocking by the store personnel. The abandoned items that the RFID Sensor Reader 12 detects as in the in appropriate or wrong location can be rescued if perishable and ready for resale in all cases so that the stock of items are in the correct shelves 18 and aisles as intended by the merchandiser. Having all products in the correct location reduces the spoilage and waste.

Thus, the exemplary systems described above allow manufacturers and marketers to target individual prospective buyers in the store using store level data and activity.

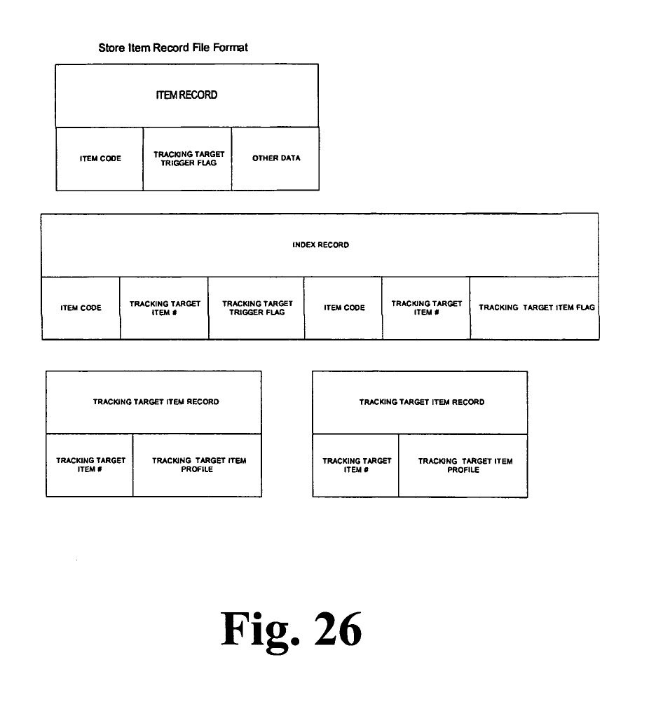

FIG. 26 is a diagram of a record file format that could be used in an exemplary embodiment. Other Data collected may include unit price, payment method, checklane ID, store log files contain the store ID, time and date etc. All data captured by the POS and scanner systems can be logged on the target file.

Thus, the exemplary systems include various types of circuitry to effect the functionality described in this Patent Application.

The preferred embodiments of the invention may be implemented with many different configurations of circuitry, depending on desired optimizations and design choices.

Although the preferred embodiments have been described above in a certain manner to facilitate ease of description of functionality, in an actual implementation processing may be preformed in serial fashion, in parallel, with software, with dedicated hardware, or in any manner to achieve desired optimizations.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

1. A method for a system including a store, the method comprising the steps, performed in the store, of:
detecting a first product selected by a consumer during a visit to the store;
generating a message, a content of the message depending on the first product detected by the detecting step;
emitting the message, during the visit to the store, the emitting step being performed at a first location, the first location being fixed;
displaying, during the visit to the store, a price for the first product, the displaying step being performed at a second location different from the first location; and
receiving payment from the consumer at the second location.

2. The method of claim 1 wherein emitting the message includes displaying a light signal for sensing by the consumer.

3. The method of claim 1 wherein emitting the message includes playing an audio signal for sensing by the consumer.

4. The method of claim 1 wherein generating the message includes generating the message to include information about another product.

5. The method of claim 1 wherein generating the message includes generating the message to include information about a product that can be used with the first product.

6. The method of claim 1 wherein generating the message includes generating the message to include information about a product that can be substituted for the first product.

7. The method of claim 1 wherein generating the message includes generating the message to include a suggestion to select an additional unit of the first product, and pricing information related to the additional unit.

8. The method of claim 1 wherein a content of the message depends on a record for the consumer, the record being compiled on a previous day.

9. The method of claim 1 wherein a content of the message depends on whether a second product has been detected.

10. The method of claim 1 wherein the consumer selects the first product by moving the first product.

11. The method of claim 10 wherein the detecting step detects the first product after the consumer moves the first product.

12. The method of claim 1 wherein the first product is on a shelf in the store, and the consumer selects the first product by moving the first product from the shelf.

13. The method of claim 1 wherein the first product is on a shelf in the store, the consumer transports a container, the consumer selects the first product by moving the first product from the shelf to the container, and
the detecting step detects the first product while the first product is in the container.

14. The method of claim 13 wherein the detecting step detects the first product while there are a plurality of other products in the container.

15. The method of claim 13 wherein the container includes a plurality of wheels.

16. The method of claim 1 wherein detecting includes receiving a signal from the first product.

17. The method of claim 16 wherein the signal includes a plurality of digits that identifies the first product.

18. The method of claim 16 wherein the signal includes a radio signal.

19. The method of claim 1 wherein generating the message includes accessing a data structure.

20. The method of claim 19 wherein the data structure includes a table.

21. The method of claim 1 wherein the fixed location is a shelf.

22. A system in a store, the system comprising:
an output device at a first fixed location;
a detector that detects a first product selected by a consumer, to generate a first signal;
a generator that generates a message and sends the message to the output device in response to the first signal; and
a display that displays a price for the first product, the display being located at a second location different from the first location.

23. The system of claim 22 wherein the output device includes a display screen.

24. The system of claim 22 wherein the generator includes logic to generate message to include information about another product.

25. The system of claim 22 wherein the generator includes logic to generate the message to include information about a product that can be used with the first product.

26. The system of claim 22 wherein the generator includes a general logic expression, and evaluator for the logical expression, and the generator conditionally sends the message to the output device depending on a result from the evaluator.

27. The system of claim 22 wherein the generator includes logic to generate the message to include a suggestion to select an additional unit of the first product, and pricing information related to the additional unit.

28. The system of claim 22 wherein a content of the message depends on a record for the consumer, the record being compiled on a previous day.

29. The system of claim 22 wherein a content of the message depends on whether a second product has been detected.

30. The system of claim 22 wherein the detector detects the first product after the consumer moves the first product.

31. The system of claim 22 wherein the first product is on a shelf in the store, and the consumer selects the first product by moving the first product from the shelf.

32. The system of claim 22 wherein the first product is on a shelf in the store, the consumer transports a container, the consumer selects the first product by moving the first product from the shelf to the container, and
the detecting step detects the first product while the first product is in the container.

33. The system of claim 32 wherein the detecting step detects the first product while there are a plurality of other products in the container.

34. The system of claim 32 wherein the container includes a plurality of wheels.

35. The system of claim 22 wherein detecting includes receiving a signal from the first product.

36. The system of claim 35 wherein the signal includes a plurality of digits that identifies the first product.

37. The system of claim 35 wherein the signal includes a radio signal.

38. The system of claim 22 wherein the generator includes accessing a data structure.

39. The system of claim 38 wherein the data structure includes a table.

40. The system of claim 38 wherein the fixed location is a shelf.

41. A system in a store, the system comprising:
means for detecting a first product selected by a consumer;
means for generating a message, a content of the message depending on the first product detected by the detecting means;
means for emitting the message, the emitting means being at a first fixed location;
means for displaying a price for the first product, the displaying means being at a second location different from the first location; and
means for receiving payment from the consumer at the second location.

42. The system of claim 41 wherein means for generating the message includes means for generating the message to include information about another product.

43. The system of claim 41 wherein means for generating the message includes means for generating the message to include information about a product that can be used with the first product.

44. The system of claim 41 wherein means for generating the message includes means for generating the message to include information about a product that can be substituted for the first product.

45. The system of claim 41 wherein means for generating the message includes generating the message to include a suggestion to select an additional unit of the first product, and pricing information related to the additional unit.

46. The system of claim 41 wherein a content of the message depends on a record for the consumer, the record being compiled on a previous day.

47. The system of claim 41 wherein a content of the message depends on whether a second product has been detected.

48. The system of claim 41 wherein the means for detecting detects the first product after the consumer moves the first product.

49. The system of claim 41 wherein the first product is on a shelf in the store, and the consumer selects the first product by moving the first product from the shelf.

50. The system of claim 41 wherein the first product is on a shelf in the store, the consumer transports a container, the consumer selects the first product by moving the first product from the shelf to the container, and
the means for detecting detects the first product while the first product is in the container.

51. The system of claim 50 wherein the means for detecting detects the first product while there are a plurality of other products in the container.

52. The system of claim 50 wherein the container includes a plurality of wheels.

53. The system of claim 41 wherein means for detecting includes means for receiving a signal from the first product.

54. The system of claim 53 wherein the signal includes a plurality of digits that identifies the first product.

55. The system of claim 53 wherein the signal includes a radio signal.

56. The system of claim 41 wherein means for generating the message includes means for accessing a data structure.

57. The system of claim 56 wherein the data structure includes a table.

58. The system of claim 41 wherein a time of activation of the emitting means depends on when the detecting means detects the first product,

59. The system of claim 41 wherein the fixed location is a shelf.
